(19) United States
(12) Patent Application Publication
(10) Pub. No.: US 2016/0275371 A1
(43) Pub. Date: Sep. 22, 2016

(54) JIG FOR MATCHING IMAGES OF COLOR CAMERA AND INFRARED CAMERA

(71) Applicant: CORESENSE CO., LTD, Yuseong-gu Daejeon (KR)

(72) Inventors: Ha-Hyoung JUNG, Daejeon (KR); Tae-Yeon KIM, Daejeon (KR); Jin-Ha PARK, Daejeon (KR); Chung-II KIM, Daejeon (KR)

(21) Appl. No.: 14/443,319

(22) PCT Filed: Jun. 26, 2014
(86) PCT No.: PCT/KR2014/005694

§ 371 Date: May 15, 2015

(30) Foreign Application Priority Data
Apr. 24, 2014 (KR) 10-2014-0049202

(51) Int. Cl. G06K 9/62; H04N 9/04; H04N 5/33; G06T 7/00

(52) U.S. Cl. CPC G06K 9/6215; G06T 7/004; G06T 7/0085; H04N 9/04; H04N 5/33; G06T 2207/20144

(57) ABSTRACT

Disclosed is a jig for matching images between a color camera and an infrared camera so as to match images into one image by correcting angles of view and degrees of distortion according to physical positional relations between the images. The jig includes a white background board having square or circular holes arranged by designated intervals in the horizontal and vertical directions and a black inner board detachably combined with the white background board so that holes formed on the white background board are expressed as black. The white background board and the black inner board are respectively kept in a normal temperature state and a refrigerated state and then combined so that, if the infrared camera is used to photograph, a black square or circular pattern may be extracted according to a temperature difference between the two boards.

### TECHNICAL FIELD

The present invention relates to a jig for matching images, and more particularly to a jig for matching images of a color camera and an infrared camera so that the image of the color camera and the image of the infrared camera may be matched into one image by correcting angles of view and degrees of distortion according to physical positional relations between the two images.

### BACKGROUND ART

In general, an image captured by a camera may require correction according to CCD sensor distortion of the camera. Such camera correction is carried out in such a manner that variables, such as a degree of distortion, a focal distance and a center point of a camera CCD sensor, are detected and corrected.

Recently, two cameras are used to photograph an object and acquired images are matched to produce a 3-dimensional stereo image. Stereo camera correction is carried out by individually correcting the two cameras having different camera variables, calculating physical positional relations between the two cameras, generating disparity between the two cameras through the variables and the physical positional relations between the two cameras, and calculating a distance from a screen to the object through the disparity.

In order to execute such camera correction, an absolute position reference point of the two camera images is required. Generally, a chessboard is used to set an absolute position reference of camera images. As a conventional chessboard used for camera correction, a general chessboard in which black and white squares are alternately arranged may be used. After respective cameras photograph the entirety of the chessboard, chessboard corners are extracted from respective acquired images and correction is carried out using the extracted corner information.

Recently, after different kinds of cameras, for example, a general color camera and an infrared camera, photograph the same object, acquired images are matched to produce one image. If the images acquired by the different kinds of cameras are matched, camera correction is also required. In this case, if the conventionally used chessboard is used, black pattern corners may be extracted from the image of the chessboard acquired by the color camera, but the image of the chessboard acquired by the infrared camera is unclear and thus it is difficult to precisely extract black pattern corners from the image of the chessboard acquired by the infrared camera and precise matching of the image acquired by the color camera and the image acquired by the infrared camera is difficult.

### PRIOR ART DOCUMENT

### Patent Document

(Patent Document 1) Korean Patent Registration No. 10-1035055 (May 9, 2011)

### SUMMARY OF THE INVENTION

### Technical Problem

Therefore, the present invention has been made in view of the above problems, and it is an object of the present invention to provide a jig for matching images of a color camera and an infrared camera through which both the color camera and the infrared camera may acquire precise images and a position serving as an image matching reference may be extracted so as to increase precision in image matching and to shorten image matching time.

### Technical Solution

In accordance with an aspect of the present invention, the above and other objects can be accomplished by the provision of a jig for matching images to provide a reference position to match images of a color camera and an infrared camera into one image, including a white background board having square or circular holes arranged by designated intervals in the horizontal and vertical directions, and a black inner board detachably combined with the rear surface of the white background board so that holes formed on the white background board are expressed as black.

Here, inner board combination grooves, along which the black inner board slides to be detachably combined with the white background board and supported by the white background board, may be formed on the rear surface of the white background board.

The edge of the white background board may be fixed to a front surface part of a fixing frame and the black inner board may be detachably combined with the rear surface of the fixing frame provided with the white background board fixed to the front surface thereof.

Inner board combination grooves, along which the black inner board slides in the vertical direction from one side to be detachably combined with the fixing frame and supported by the fixing frame, may be formed on the rear surface of the fixing frame, and handles may be attached to both side surfaces of the fixing frame.

The white background board and the black inner board may be respectively kept in a normal temperature state and a refrigerated state and then combined so that, if the infrared camera is used to photograph, a black square or circular pattern may be extracted according to a temperature difference between the white background board and the black inner board.

### Advantageous Effects

A jig for matching images of a color camera and an infrared camera in accordance with the present invention allows both the color camera and the infrared camera to precisely capture images through color and temperature differences between a white background board and a black inner board and precisely extracts an image matching reference position, thus being capable of precisely and rapidly matching the image captured by the color camera and the image captured by the infrared camera.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a jig for matching images in accordance with the present invention;

FIG. 2 is a front view of a white background board of the jig for matching images in accordance with the present invention;

FIG. 3 is a front view of a block inner board of the jig for matching images in accordance with the present invention;

FIG. 4 is a perspective view of the jig for matching images in accordance with the present invention in an assembled state;

FIG. 5 is a front view of the jig for matching images in accordance with the present invention in the assembled state;

FIG. 6 is a sectional view of the jig for matching images in accordance with the present invention in the assembled state;

FIG. 7 is a plan view illustrating a process of combining the black inner board with the jig for matching images in accordance with the present invention;

FIG. 8 illustrates one example of stereo correction by sequentially aligning corner points of an extracted black square pattern in accordance with the present invention;

FIG. 9 illustrates images of the jig for matching images in accordance with the present invention, acquired by a color camera and an infrared camera;

FIG. 10 illustrates images acquired by the color camera and the infrared camera and corrected using the jig for matching images in accordance with the present invention;

FIG. 11 is an exploded perspective view of a jig for matching images in accordance with another embodiment of the present invention; and

FIG. 12 is a perspective view of the jig for matching images in accordance with the embodiment of the present invention in an assembled state.

### DETAILED DESCRIPTION OF PREFERRED EMBODIMENTS

Hereinafter, preferred embodiments of the present invention will be described in detail with reference to the accompanying drawings.

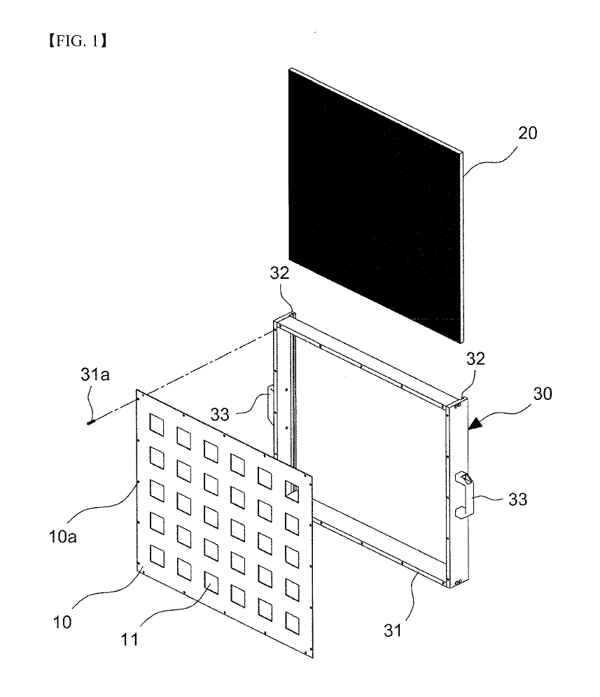

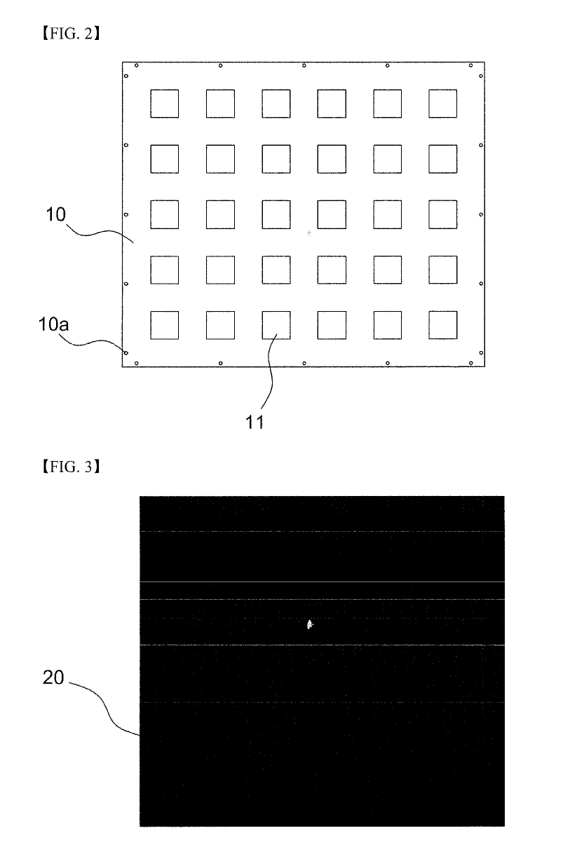

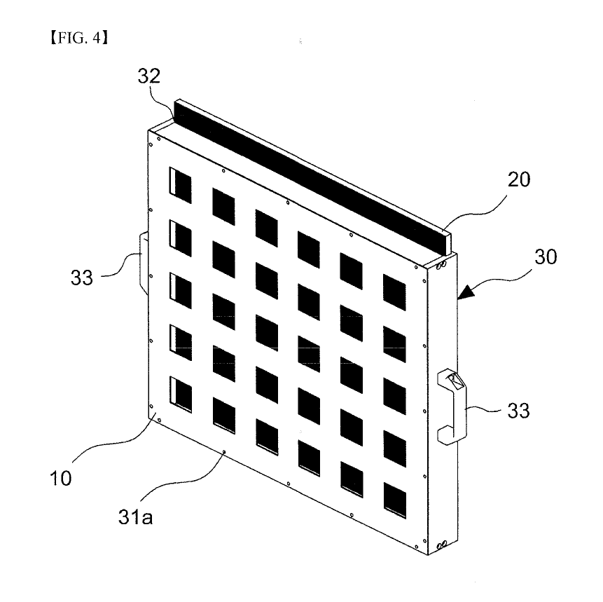

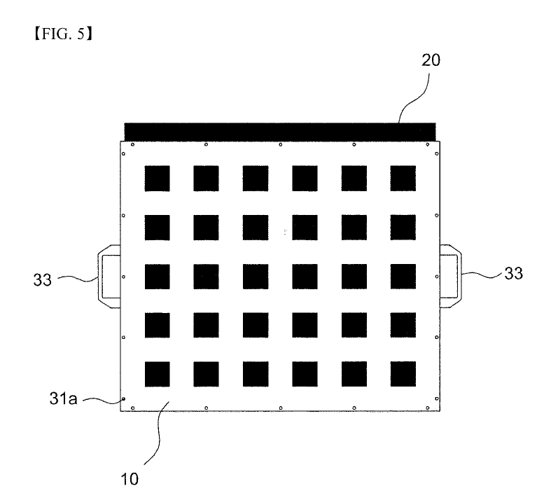

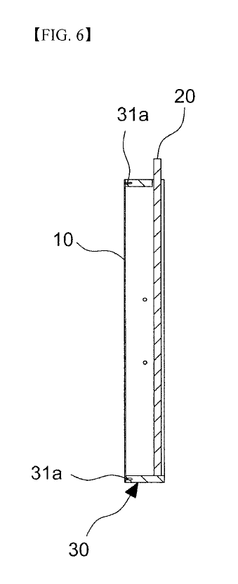

FIG. 1 is an exploded perspective view of a jig for matching images in accordance with the present invention, FIG. 2 is a front view of a white background board of the jig for matching images in accordance with the present invention, FIG. 3 is a front view of a block inner board of the jig for matching images in accordance with the present invention, FIG. 4 is a perspective view of the jig for matching images in accordance with the present invention in an assembled state, FIG. 5 is a front view of the jig for matching images in accordance with the present invention in the assembled state, and FIG. 6 is a sectional view of the jig for matching images in accordance with the present invention in the assembled state.

The jig for matching images in accordance with the present invention shown in FIGS. 1 to 6 is a device for providing an absolute reference position required to match an image captured by a color camera and an image captured by an infrared camera into one image, and the jig for matching images includes a white background board 10 having rectangular holes 11 formed by designated intervals in the horizontal and vertical directions, a fixing frame 30 supporting the white background board 10 fixed to the front surface thereof, and a black inner board 20 detachably combined with the rear surface of the fixing frame 30 provided with the front surface to which the white background board 10 is fixed. In the present invention, white and black do not mean precise white and black colors but mean whitish and blackish colors so that the two colors may be contrasted with each other and show a color difference.

In the embodiment of the present invention, the white background board 10 is formed of stainless steel (STS304) and white acetal and is manufactured to have a rectangular shape. The holes 11 formed in a designated pattern are formed on the white background board 10, such a hole pattern includes 6 square holes 11 arranged in the horizontal direction and 5 square holes 11 arranged in the vertical direction, and the holes 11 formed on the white background board 10 may be formed by punching. Further, joint holes 10a are formed on the edge of the white background board 10 so as to fix the white background board 10 to the front surface of the fixing frame 30 through fixtures 31a, such as screws.

The black inner board 20 is formed of aluminum (AL6061) and is manufactured to have a rectangular shape having a black front surface so that the black inner board 20 may be detachably combined with the rear surface of the white background board 10 so as to be exposed to the outside through the square holes 11 formed on the white background board 10. Since the black inner board 20 may have a sufficient size to cover all of the square holes 11 formed on the white background board 10, the black inner board 20 in the embodiment of the present invention is manufactured to have a sufficient size to be detachably combined with the rear surface of the fixing frame 30 through sliding.

The fixing frame 30 is a frame, the front and rear portions of which are opened, and serves to support the white background board 10 fixed to the front surface thereof and to detachably combine the black inner board 20 with the rear surface thereof. In the embodiment of the present invention, the fixing frame 30 is formed of aluminum (AL6061) and is manufactured to have a rectangular frame structure, and a frame front part 31 of the fixing frame 30 serves as a background board fixing part, with which the edge of the white background board 10 is combined through the fixtures 31a, such as screws. Inner board combination grooves 32, along which the black inner board 20 slides in the vertical direction from one side to be detachably combined with the fixing frame 30, are formed on the rear surface of the rectangular fixing frame 30. That is, one side of the edge of the rear surface of the fixing frame 30 is opened so that the black inner board 20 is inserted into the fixing frame 30 through the opened side of the edge of the rear surface of the fixing frame 30, and the inner board combination grooves 32 having guide grooves are formed inwardly from the opened side of the edge of the rear surface of the fixing frame 30, thus allowing the black inner board 20 to be slidably inserted into the fixing frame 30. Further, handles 33 formed of aluminum are attached to both side surfaces of the fixing frame 30. Such handles 33 are used to carry the fixing frame 30.

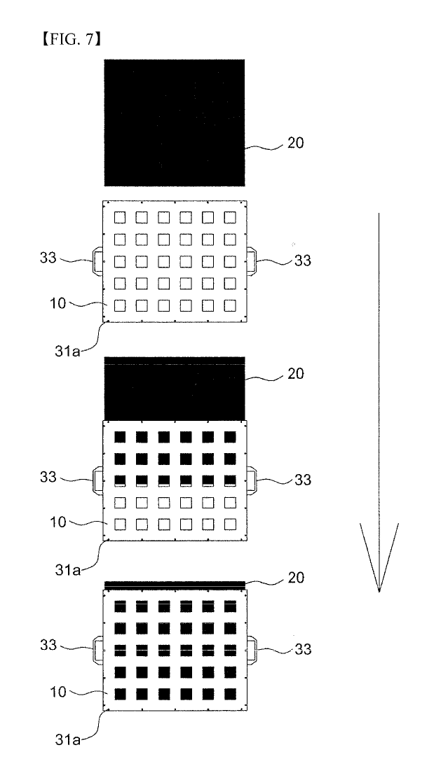

FIG. 7 is a plan view illustrating a process of combining the black inner board with the jig for matching images in accordance with the present invention. At normal times, the white background board 10 is kept combined with the fixing frame 30 and the black inner board 20 is kept separated from the fixing frame 30 and, in use, the black inner board 20 is combined with the fixing frame 30 through the inner board combination grooves 32 of the fixing frame 30.

In the present invention, the reason why the black inner board 20 is detachably combined with the fixing frame 30 is that, by keeping the black inner board 20 in a refrigerated state separately from the fixing frame 30, the black inner board 20 has a different temperature from the temperature of the white background board 10 and, when the infrared camera is used to photograph, image recognition is carried out according to a temperature difference between the black inner board 20 and the white background board 10.

That is, if the color camera is used to photograph under the same temperature conditions in a state in which the black inner board 20 is combined with the fixing frame 30, the white background board 10 and the black inner board 20 are distinguishable due to a color difference but, if the infrared camera is used to photograph, it is difficult to distinguish the white background board 10 and the black inner board 20 from each other under the same temperature conditions. Therefore, in the present invention, the white background board 10 is kept in a normal temperature state and the black inner board 20 is kept in a refrigerated state using a refrigerator and the like and, in order to use the infrared camera, the black inner board 20 kept in the refrigerated state is combined with the inner board combination grooves 32 of the fixing frame 30 having the white background board 10 combined with the front surface thereof and then the infrared camera is used to photograph. Thereby, the infrared camera may recognize a temperature difference between the white background board 10 and the black inner board 20 and thus extract the black square pattern displayed on the square holes 11 of the white background board 10.

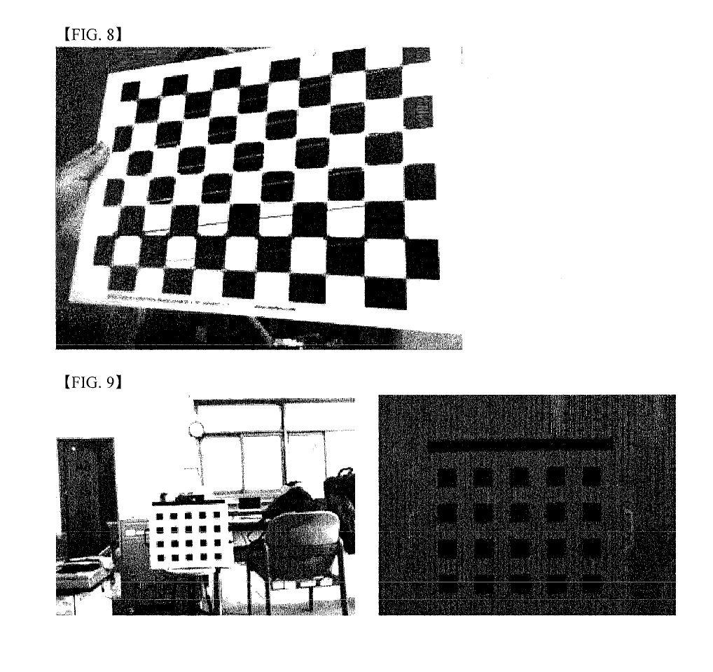

When the color camera and the infrared camera are used to photograph and black square patterns are extracted, respective square corner points may be detected through the extracted black square patterns. When the square corner points are detected, stereo correction may be performed by sequentially aligning the square corner points in the same manner as the general stereo correction process. FIG. 8 illustrates one example of stereo correction by sequentially aligning corner points of an extracted black square pattern in accordance with the present invention.

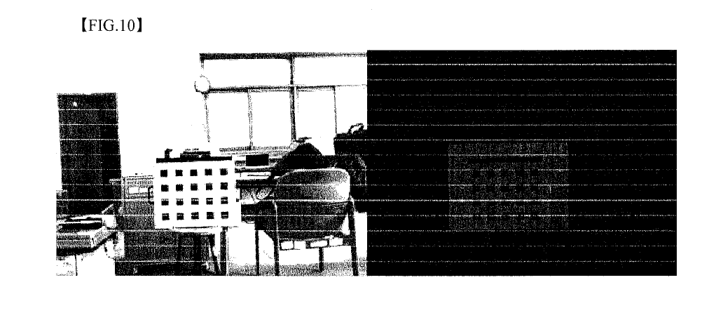

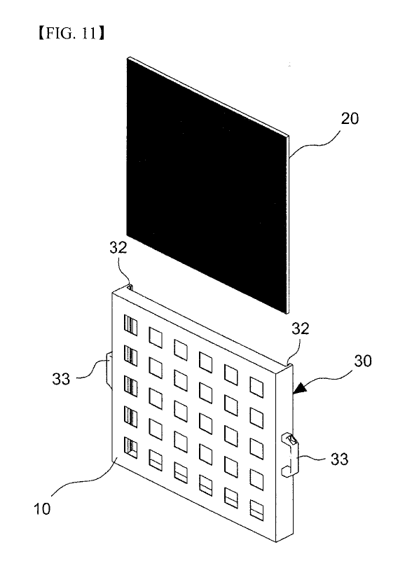

Further, FIG. 9 illustrates images of the jig for matching images acquired by a color camera and an infrared camera, and FIG. 10 illustrates two images acquired by the color camera and the infrared camera and corrected using the jig for matching images. When black square patterns of the two images are extracted, the two images may be corrected through the extracted black square patterns so that the positions thereof coincide with each other, thereby being capable of being matched into one image.

As described above, the jig for matching images in accordance with the present invention allows both a color camera and an infrared camera to acquire recognizable images through the white background board 10 and the black inner board 20 kept at different temperatures and thereby, the image acquired by the color camera and the image acquired by the infrared camera may be matched into one image.

Although the above-described embodiment describes the white background board 10 and the black inner board 20 as being combined with the fixing frame 30, the fixing frame 30 serves as a unit with which the black inner board 20 is detachably combined and thus, the white background board 10 may have the function of the fixing frame 30.

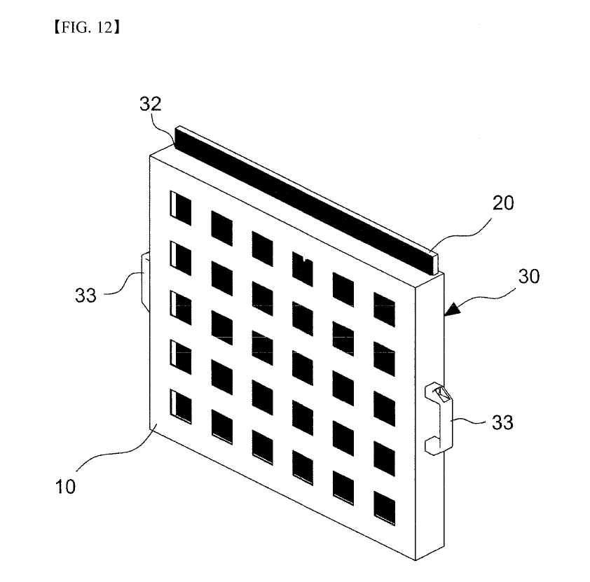

FIG. 11 is an exploded perspective view of a jig for matching images in accordance with another embodiment of the present invention and FIG. 12 is a perspective view of the jig for matching images in accordance with the embodiment of the present invention in an assembled state.

As exemplarily shown in FIGS. 11 and 12, in this embodiment of the present invention, a white background board 10 serves as a fixing frame without a separate fixing frame. That is, rectangular holes 11 are formed on the front surface of the white background board 10 by designated intervals in the horizontal and vertical directions by punching, handles 33 are installed on the side surfaces of the white background board 10, and inner board combination grooves 32, along which a black inner board 20 slides so as to be detachably combined with the white background board 10, are formed on the rear surface of the white background board 10.

In such a jig for matching images including the white background board 10 and the black inner board 20, the white background board 10 and the black inner board 20 are separated from each other and kept at different temperatures and, in use, the white background board 10 and the black inner board 20 are combined so that a color camera and an infrared camera may photograph the jig for matching images and recognize black patterns.

As described above, the jig for matching images in accordance with the present invention is configured such that the black inner board 20 is detachably combined with the white background board 10 on which the rectangular holes 11 are formed by designated intervals in the horizontal and vertical directions, and allows a color camera and an infrared camera to extract black square patterns through a color difference and a temperature difference between the white background board 10 and the black inner board 20 so as to perform stereo correction, thereby achieving precise and rapid image matching.

Further, although the above-described embodiments illustrate the holes formed on the white background board 10 of the jig for matching images as having a square shape, the holes may have other shapes allowing cameras to recognize a pattern, for example, a circular shape. That is, if the holes formed on the white background board 10 have a circular shape, a back circular pattern may be extracted using the conventional stereo correction method and stereo correction may be carried out by detecting central points of circles of the extracted black circular pattern and sequentially aligning the detected central points.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

[Description of reference numerals]

| | |
|---|---|
| 10: background board | 10a: joint hole |
| 11: square hole | 20: inner board |
| 30: fixing frame | 31: fixing frame front part |
| 31a: fixture | 32: inner board combination groove |
| 33: handle | |

1. A jig for matching images to provide a reference position to match images of a color camera and an infrared camera into one image, comprising:
a white background board (10) having square or circular holes arranged by designated intervals in the horizontal and vertical directions; and
a black inner board (20) detachably combined with the rear surface of the white background board (10) so that holes formed on the white background board (10) are expressed as black.

2. The jig for matching images according to claim 1, wherein inner board combination grooves (32), along which the black inner board (20) slides to be detachably combined with the white background board (10) and supported by the white background board (10), are formed on the rear surface of the white background board (10).

3. The jig for matching images according to claim 1, wherein:
the edge of the white background board (10) is fixed to a front surface part (31) of a fixing frame (30); and
the black inner board (20) is detachably combined with the rear surface of the fixing frame (30) provided with the white background board (10) fixed to the front surface thereof.

4. The jig for matching images according to claim 3, wherein inner board combination grooves (32), along which the black inner board (20) slides from one side to be detachably combined with the fixing frame (30) and supported by the fixing frame (30), are formed on the rear surface of the fixing frame (30).

5. The jig for matching images according to claim 3, wherein handles (33) are attached to both side surfaces of the fixing frame (30).

6. The jig for matching images according to any one of claims 1 to 5, wherein the white background board (10) and the black inner board (20) are respectively kept in a normal temperature state and a refrigerated state and then combined so that, if the infrared camera is used to photograph, a black square or circular pattern may be extracted according to a temperature difference between the white background board (10) and the black inner board (20).
